(19) United States
(12) Patent Application Publication
(10) Pub. No.: US 2006/0243085 A1
(43) Pub. Date: Nov. 2, 2006

(54) Spherical motion mechanism

(76) Inventors: Blake Hannaford, Seattle, WA (US); Jacob Rosen, Seattle, WA (US); Dennis Trimble, Seattle, WA (US); Mitchell Lum, Seattle, WA (US); Manuel Moreyra, Shoreline, WA (US); Mika Sinanan, Brier, WA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/113,824

(22) Filed: Apr. 25, 2005

(51) Int. Cl. B25J 17/00

(52) U.S. Cl. 74/490.01

(57) ABSTRACT

This document discusses, among other things, a mechanism for providing motion having two degrees of freedom and centered on a single point within a sphere. Methods to design the mechanism consistent with specified parameters are also described.

### GOVERNMENT FUNDING

The subject matter described herein was made with U.S. Government support under contract or grant number DAMD17-02-1-0202 entitled “MiniRobot Design for Military Telesurgery in the Battlefield: Breaking the Size Barrier for Surgical Manipulators,” project period May 01, 2002-Apr. 20, 2006, awarded by the Department of the Army. The United States Government has certain rights in the invention.

### TECHNICAL FIELD

This document pertains generally to mechanical linkages, and more particularly, but not by way of limitation, to a spherical motion mechanism.

### BACKGROUND

Robotically controlled surgical methods, such as laparoscopy, hold the promise of bringing advanced medical procedures to the battlefield and other remote locations throughout the globe. Typical systems are often too large, heavy and cumbersome to be effective in an operating room. In addition, typical systems are subject to device collisions.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 includes a perspective view of a serial version of a spherical motion mechanism.

FIG. 2 includes a side view of a spherical motion mechanism.

FIG. 3 includes a motor driven spherical motion mechanism with a linear actuator.

FIG. 4 includes a parallel version of a spherical motion mechanism.

FIG. 5 includes a flow chart of a method for selecting a design of a spherical motion mechanism.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present subject matter includes a spherical motion mechanism suitable for a variety of applications, including for example, manipulating a minimally invasive surgery (MIS) instrument. The mechanism includes a first revolute joint connected to a link with a less than right angle between the link and the axis of rotation for the first revolute joint. At the other end of the first link is a second revolute joint with a less than right angle between the first link and the axis of rotation for the second revolute joint and a less than right angle between the axis of rotation and the second link. Additional links can be added at the end of the first two links.

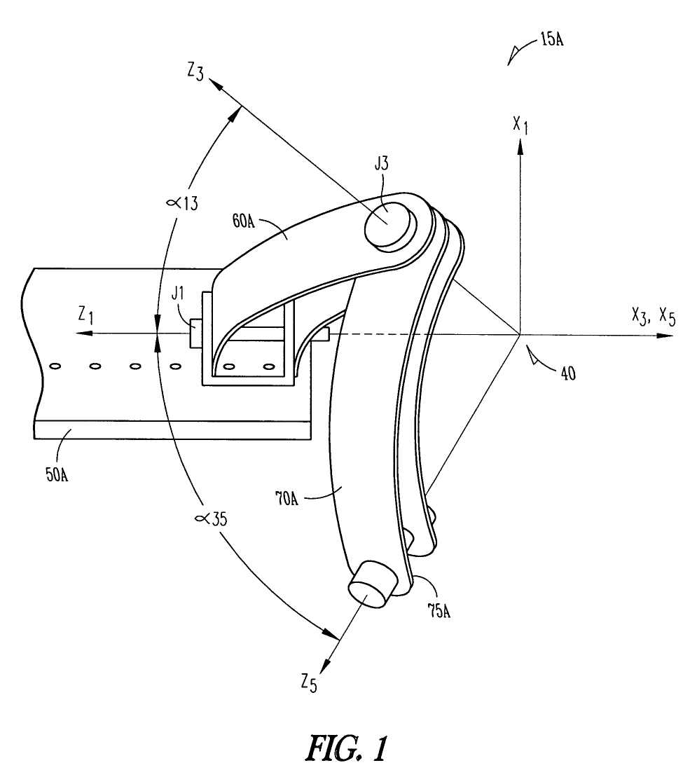

In one example, a device includes two links configured as described and illustrated in FIG. 1. The axes of rotation of the revolute joints converge, or alternatively intersect, at a point remote from the device. This intersection constrains the end link or effector to move about the surface of a sphere where the center of the sphere lies at the intersection of the axes of rotation.

In one example, the device includes a single series of two links however multiple links can be used wherein additional links are connected at the last link to form a parallel version.

A load can be placed at the end link. In various examples, the load includes a manipulator, an optical device, an audio device, a probe, an electrical device or other such device. The device focuses at the center of the sphere.

In one example, the load includes a tool or surgical instrument having a longitudinal tool axis. The instrument can be aligned such that the longitudinal axis passes through the center of the sphere. Rotation of the instrument about the longitudinal tool axis then passes through the center as well as any prismatic motion of the instrument. The center or origin of the sphere can be placed coincident with the MIS trocar.

In one example, the device is used as an imager. The center of the sphere can be located inside a patient (since the center of the sphere is separate and remote from the device) and an image of a focused area inside the patient can be created. The focused area can be at or about the center of the sphere.

In addition to surgical and medical applications, the device can be configured for manipulating and assembling small scale components.

In one example, subject matter also includes a processor-executable algorithm to select a design of the mechanism. In one example, data corresponding to motion occurring during actual surgical procedures is used to define both a dexterous workspace (DWS) and an extended dexterous workspace (EDWS). In one example, a method includes maximizing a measure of device ability to easily move in the DWS while still reaching all the EDWS called isotropy. In one example, parameters describing rotational inertia and the device stiffness are optimized. Other parameters or factors can be optimized including, for example, the sphere radius.

One example of this device includes two (or multiples of two) links to mechanically constrain two degrees of motion to the surface of a sphere. The motion in two degrees intersects or converges at one point defining a sphere. When a linear instrument is positioned at the end of the two (or multiples of two) links of such a device, the device constrains an axis of the instrument to intersect the center of the sphere for any configuration of the device. A minimally invasive surgical (MIS) instrument may be placed at the end of the two (or multiples of two) links and the rotation of said instrument will intersect the sphere. The device may be placed in a position where that instrument may function as normal but with a new, mechanically constrained and non-patient based, fulcrum of motion.

The sphere center can be placed in the trocar or at an arbitrary point internal or external to the patient's body. For example, when the sphere center is positioned outside the body, a mechanical support can be used to position the tool (between the base and sphere center) for use in open surgery.

The design of specific physical parameters used relevant data to optimize those parameters to maximize dexterity and minimize weight for the given purpose.

In the present subject matter, the rotation axes of two or more links are aligned to converge or intersect in a single point. At least one link or other structure is flexibly mounted and free to encircle the single point while traveling about the surface of a sphere centered on the single point. The single point, in various examples, is at or near the center of the mechanism.

In one example, the rotation axes intersect. In other examples, the rotation axes converge without intersecting, in which case, the discussion herein regarding point of intersection refers to a point at or near the minimum separation distance of the axes.

In the context of MIS, the point of intersection can be aligned with the location of the port through which a tool is inserted into the body. At the point of intersection, for example, movement of the tool is restricted to a generally conical volume with the vertex at the port. In addition, with a suitable joint, the tool is allowed to travel along an axis aligned with the point of intersection.

With respect to FIG. 1, center 40 of the sphere is the origin for the reference frames of the mechanism. Thus, each link frame is a pure rotation from one to the next.

The frames are assigned such that the z-axis of the n^{th} frame points outward along the n^{th} joint. The numbering scheme for the frames includes odd numbers (frames 0′, 1, 3 and 5). The end-effector, frame is frame 5. Frame 0′ is oriented such that the z-axis points along joint 1 and the y-axis points to the apex of the sphere.

The odd number subscript notations 0′, 1, 3, 5 of the present subject matter provides symmetry with an even side notation of 0″, 2, 4 and 6 of a parallel mechanism. The frames can be viewed as a shoulder, an elbow and a tool axis.

The link angle, αᵢ+2 expresses the angle between the i^{th} and (i+2)^{th} axis. These are fixed parameters defined by the mechanism geometry. The rotation angle θᵢ defines the angle as a function of time between the rotation axis i−2 and i. When all joint angles are set to zero (θ₁=θ₃=0), link α₁₃ lies in a plane defined by Z_{0′} and Y_{0′}, link α₃₅ is folded back on link α₁₃.

Accordingly, FIG. 1 illustrates serial configured spherical motion mechanism 15A with coordinates Z₁, Z₃ and Z₅. Mechanism 15A includes base 50A coupled to link 60A at joint J1 at a first or base end. Axis Z₁ passes through revolute joint J1. In addition, second revolute joint J3 is located at a second end of link 60A. Axis Z₃ passes through revolute joint J3. Mechanism 15A also includes link 70A coupled to joint J3 at one end and having end 75A at a second end. Axis Z₅ passes through end 75A, and in various examples, includes a tool or a instrument having an axis aligned with center 40. In one example, end 75A includes a prismatic joint.

In various examples, the length, or angle of link 60A may be the same or different from the length, or angle of link 70A.

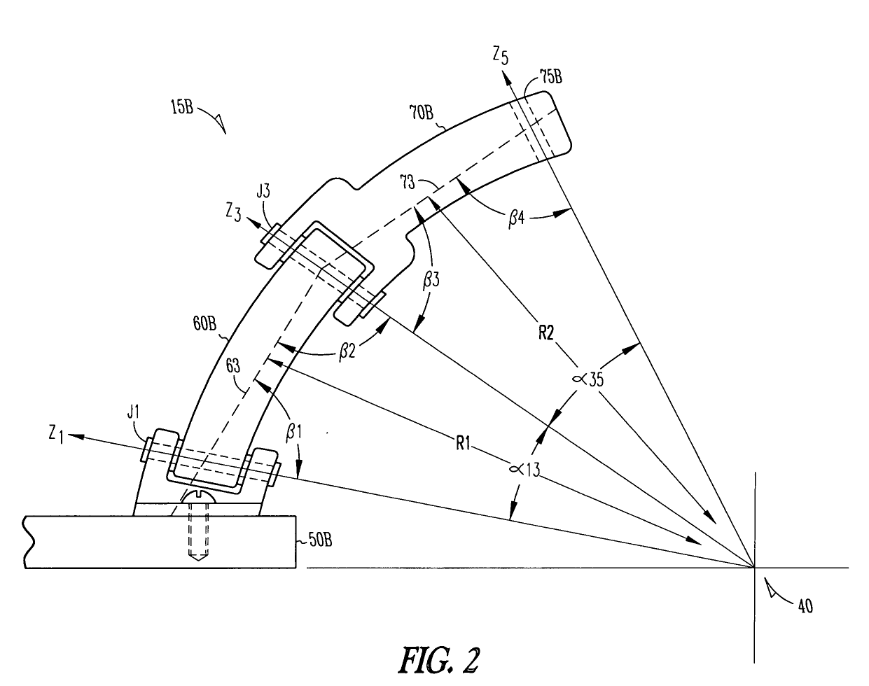

FIG. 2 illustrates a generalized view of spherical motion mechanism 15B. In the figure, base 50B is immobilized with respect to center 40, however, in other examples, base 50B is flexibly mounted. Joint J1 is affixed to base 50B by a threaded fastener and has axis Z₁ aligned with center 40. Dimension R1 is a measure of the length of the radius describing link 60B. As illustrated, linear length 63 passes through joint J1 and joint J3. In addition, dimension R2 is a measure of the length of the radius describing link 70B. As illustrated, linear length 73 passes through joint J3 and joint J5.

In the figure, interior angles β1, β2, β3 and β4 are all acute, however, in one example, at least one angle is 90 degrees.

The transformation matrices between frames are based on the Denavit-Hartenberg (DH) parameter notation and summarized in Table I. Since no translations exist between the assigned coordinate systems, the transformation matrix is reduced from the typical 4×4 matrix to a 3×3 rotation matrix.

TABLE I
Serial Manipulator D-H Parameters

| i − 1 | i | i + 1 | αᵢ₋₁ | θᵢ |
|---|---|---|---|---|
| ^{0′} | 1 | 3 | 0 | θ₁ |
| 1 | 3 | 5 | −α₁₃ | θ₃ |
| 3 | 5 | — | α₃₅ | −θ₅ = 0 |

As used herein, the term α refers to a “twist angle” in the DH notation and is considered an angular “link length.” The twist angle can be viewed as the “angle between axes of rotation” where the axes intersect at a point. In the DH notation, twist angle is defined as the angle between the axes measured about the common normal. Thus, for axes that tend to converge (such as two skew axes that are non-ntersecting and non-parallel), the term α refers to a measure of an angle between the two axes about a line perpendicular (normal) to both axes.

Given the mechanism parameters (αᵢ,θᵢ) the forward kinematics aimed to express the orientation of the end-effector ^{0′}u expressed in frame 0′. Using the DH notation along with the DH parameters defined in Table I, the generalized rotation matrix is defined as follows:

$${}_{i}^{i - 1} R = [ \begin{matrix}cos {θ}_{i} & - sin {θ}_{i} & 0 \\ sin {θ}_{i} * cos {α}_{i - 1} & cos {θ}_{i} * cos {α}_{i - 1} & - sin {α}_{i - 1} \\ sin {θ}_{i} * sin {α}_{i - 1} & cos {θ}_{i} * sin {α}_{i - 1} & cos {α}_{i - 1}\end{matrix} ] \qquad ( 1 )$$

The forward kinematics from the base, Frame 0′ to the end effector, Frame 5 is the product of those rotation matrices.
₅^{0′}R=₁^{0′}R*₃¹R*₅³R (2)

Rather than expressing the entire end-effector frame it is sensible to express a vector that represents the axis along which the surgical tool will point. In one example, tool roll θ₅ is designed onto the distal end of the mechanism. Let ^{0′}u be a vector pointing along the end-effector axis, z₅ expressed in Frame 0′.

$$\begin{matrix}{}^{{0}^{′}} u = {}_{5}^{{0}^{′}} R * [ \begin{matrix}0 \\ 0 \\ 1\end{matrix} ] \\ = [ \begin{matrix}{}_{}^{{0}^{′}}{u}{}_{x}^{} \\ {}_{}^{{0}^{′}}{u}{}_{y}^{} \\ {}_{}^{{0}^{′}}{u}{}_{z}^{}\end{matrix} ] \\ = [ \begin{matrix}cos {θ}_{1} * sin {θ}_{3} * sin {α}_{35} + sin {θ}_{1} * cos {θ}_{3} * cos {α}_{13} * sin {α}_{35} - sin {θ}_{1} * sin {α}_{13} * cos {α}_{35} \\ sin {θ}_{1} * sin {θ}_{3} * sin {α}_{35} - cos {θ}_{1} * cos {θ}_{3} * cos {α}_{13} * sin {α}_{35} - cos {θ}_{1} * sin {α}_{13} * cos {α}_{35} \\ cos {θ}_{3} * sin {α}_{13} * sin {α}_{35} + cos {α}_{13} * cos {α}_{35}\end{matrix} ]\end{matrix} \qquad ( 3 )$$

From the vector ^{0′}u that expresses the z-axis of the end-effector and the mechanism parameters (αᵢ₋₁), the inverse kinematics express the mechanism joint angles θᵢ. Using the expression for ^{0′}u_{z} (the third line of ^{0′}u—Eq. 3) and solving for cos θ₃ results in

$$cos {θ}_{3} = \frac{{}_{}^{{0}^{′}}{u}{}_{z}^{} - cos {α}_{13} * cos {α}_{35}}{sin {α}_{13} * sin {α}_{35}} \qquad ( 4 )$$

Given the expression for cosine of θ₃ there are two possible solutions for θ₃, one corresponding to an elbow up and one for the elbow down configuration. The two solutions for θ₃ are as follows:
θ₃ₐ, θ_{3b}=a tan 2(±\sqrt{1−cos² θ₃},cos θ₃) (5)

Using the expression for ^{0′}uₓ ^{0′}u_{y} (the first and second lines of ^{0′}u—Eq. 3) and solving for sin θ₁ and cos θ₁ and finally θ₁ results in Eq. 6.

$$cos {θ}_{1} = \frac{{}_{}^{{0}^{′}}{u}{}_{x}^{} * sin {θ}_{3} * sin {α}_{35} - {}_{}^{{0}^{′}}{u}{}_{y}^{} * ( cos {θ}_{3} * cos {α}_{13} * sin {α}_{35} - sin {α}_{13} * cos {α}_{35} )}{{( sin {θ}_{3} * sin {α}_{35} )}^{2} + {( cos {θ}_{3} * cos {α}_{13} * sin {α}_{35} - sin {α}_{13} * cos {α}_{35} )}^{2}} \\ sin {θ}_{1} = \frac{{}_{}^{{0}^{′}}{u}{}_{y}^{} * sin {θ}_{3} * sin {α}_{35} - {}_{}^{{0}^{′}}{u}{}_{x}^{} * ( cos {θ}_{3} * cos {α}_{13} * sin {α}_{35} - sin {α}_{13} * cos {α}_{35} )}{{( sin {θ}_{3} * sin {α}_{35} )}^{2} + {( cos {θ}_{3} * cos {α}_{13} * sin {α}_{35} - sin {α}_{13} * cos {α}_{35} )}^{2}} \\ {θ}_{1} = a tan 2 ( sin {θ}_{1} , cos {θ}_{1} ) \qquad ( 6 )$$

Once the values for θ₃ corresponding to elbow up/down configurations are solved, the associated values for θ₁ can be solved using Eq. 6. Thus the inverse kinematic equations provide two solutions to the pose of the manipulator, θ₁ₐ and θ₃ₐ, and θ_{1b} and θ_{3b}.

The Jacobian matrix relates joint velocities to end-effector angular velocities. It can be expressed with respect to anyone of the frames associated with the mechanism. If the Jacobian is expressed in Frame 5, the eigenvalue corresponding to the angular velocity of Frame 5 has a value of 1 for all poses and joint velocities. This reduction in the Jacobian dimensions allows one to use the upper 2×2 submatrix of the 3×3 Jacobian. This truncated version of the Jacobian relates the two controlled joint velocities, 1 and 3 to end-effector velocity. In the most general sense a recursive expression of the angular velocity is expressed in Eq. 7.
[ⁱ⁺¹ωᵢ₊₁]=[₁ⁱ⁺¹R][ⁱωᵢ]+θᵢ₊₁ⁱ⁺¹\hat{z}ᵢ₊₁ (7)

By distributing and rearranging, the expression from the end effector frame, Frame 5, to the base frame, Frame 0′ is stated as

$$[ {}_{}^{5}{ω}{}_{5}^{} ] = [ \begin{matrix}5 \\ 1\end{matrix} R ] [ \begin{matrix}0 \\ 0 \\ 1\end{matrix} ] {\dot{θ}}_{1} + [ \begin{matrix}5 \\ 3\end{matrix} R ] [ \begin{matrix}\begin{matrix}0 \\ 0\end{matrix} \\ 1\end{matrix} ] {\dot{θ}}_{3} + [ \begin{matrix}\begin{matrix}0 \\ 0\end{matrix} \\ 1\end{matrix} ] {\dot{θ}}_{5} \qquad ( 8 )$$

which is translated into:

$$[ \begin{matrix}{}_{}^{5}{ω}{}_{5 x}^{} \\ {}_{}^{5}{ω}{}_{5 y}^{} \\ {}_{}^{5}{ω}{}_{5 z}^{}\end{matrix} ] = [ \begin{matrix}5 \\ 1\end{matrix} R ] [ \begin{matrix}0 \\ 0 \\ 1\end{matrix} ] [ \begin{matrix}5 \\ 3\end{matrix} R ] [ \begin{matrix}\begin{matrix}0 \\ 0\end{matrix} \\ 1\end{matrix} ] [ \begin{matrix}\begin{matrix}0 \\ 0\end{matrix} \\ 1\end{matrix} ] [ \begin{matrix}\begin{matrix}{\dot{θ}}_{{1}^{*}} \\ {\dot{θ}}_{3}\end{matrix} \\ {\dot{θ}}_{5}\end{matrix} ] \qquad ( 9 )$$

Based on the previous justification, the upper 2×2 submatrix of the full 3×3 Jacobian is taken resulting in a truncated 2×2 version relating the controlled axes of motion to the end effector velocity, expressed in Eq. 10.

$$[ \begin{matrix}{}_{}^{5}{ω}{}_{5 x}^{} \\ {}_{}^{5}{ω}{}_{5 xy}^{}\end{matrix} ] = {[ {J}_{5 truncated} ]}_{2 \times 2} [ \begin{matrix}{\dot{θ}}_{1} \\ {\dot{θ}}_{3}\end{matrix} ] \qquad ( 10 )$$

This version of the Jacobian is further used for calculating the manipulator isotropy, to be discussed elsewhere in this document.

In one example, data is collected corresponding to measurements of the position and orientation of two endoscopic tools along with the forces and torques applied to the tools in a minimally invasive environment. Analysis of a database of generic surgical tasks (including tissue handling/examination, tissue dissection, and suturing) performed on an animal model in-vivo by 30 surgeons in a MIS environment indicates that for 95% of the time, the positions of the surgical tools encompass a 60° cone with a tip located at the port. In addition, measuring the reachable workspace of an endoscopic tool performed on a human model showed that in order to reach the full extent of the abdomen the tool needed to move 90° in the lateral/medial direction (left to right) and 60° in the superior/inferior (foot to head) direction.

The reachable workspace of the spherical manipulator is a sector of a sphere. The size and the shape of this sector are determined by the mechanism link lengths (α₁₃, α₃₅) and joint limits. Based on the in-vivo measurements, for one example, the dexterous workspace (DWS) for the surgical robot was defined as the area on the sphere bounded by the closed line created when a right circular cone with a circular cross section and a vertex angle of 60° located at the center of the sphere intersected the sphere. The extended dexterous workspace (EDWS) of the surgical robot was defined in a similar manner, however, the ‘cone’had an elliptical cross section created by two orthogonal vertex angles of 60° and 90°. The optimization process is directed to defining the mechanism parameters (link lengths) allowing it to reach the EDWS and provide high dexterity in the DWS.

The links of the present subject matter lie on the surface of a sphere of a particular radius. As such, their length can be measured by the angular extent between the two axes, one at each end and both intersecting or converging at the center of the sphere. Accordingly, link length refers to the angular extent between the two motion axes defining the link ends.

In one example, a compromise between the general objective to design a small form factor mechanism with a high dexterity workspace sufficiently large enough to reach the extended workspace as required in surgery was achieved by optimizing the mechanism link lengths to allow maximal dexterity in the DWS while including the EDWS in its reachable workspace.

Mathematically, the manipulator can move through singularities, fold on itself and overlap with external objects without regard to how a physical device might accomplish this.

Based on the mechanical design limits of the mechanism, in one example, the range of motion of the first joint angle is 180° (0°<θ₁<180°) and the range of motion of the second angle is 160° (20°<θ₃<180°). These constrains were further used to limit the space from which an optimal solution was searched.

The Jacobian matrix allows analysis of the kinematic performance of a mechanism. One performance metric using the Jacobian matrix is mechanism manipulability. This analysis uses mechanism isotropy as the performance metric. Isotropy is defined in Eq. 11 as the ratio between the lowest eigenvalue and the highest eigenvalue of the Jacobian.

$$ISO ( {θ}_{1} , {θ}_{3} ) = \frac{{λ}_{min}}{{λ}_{max}} ISO ∈ 〈 0 , 1 〉 \qquad ( 11 )$$

Given a design candidate (that is, a pair of link angles α₁₃ and α₃₅), for every given mechanism pose, the associated isotropy value is in the range of 0 to 1. An isotropy measure of 0 means the mechanism is in a singular configuration and has lost a degree of freedom. A measure of one means that the eigenvalues of the Jacobian are all equal and the mechanism can move equally well in all directions.

Once the kinematic equations and a performance measure are defined, one can take a design candidate with link angles α₁₃, α₃₅, and evaluate the performance at each point in mechanisms workspace. The integration of the isotropy over a DWS or EDWS is used as one of the parameters to define a scoring value for a specific mechanism candidate.

In one example, each design candidate (that is, a pair of link angles α₁₃ and α₃₅) is assigned a single score so the best overall manipulator design can be selected. Three individual criteria including: (1) an integrated average score; (2) a minimal single score; and (3) the cube of the angular length of the links are incorporated into the composite score and expressed in Eq. 13.

Mechanism isotropy is a performance measure for a particular pose of the manipulator. In order to analyze the mechanism, a hemisphere is discretized into points distributed equally in azimuth and elevation. This distribution causes each point to be associated with a different area based on elevation. One measure of how well a manipulator performs is to calculate the isotropy at each point, multiply by its corresponding area then sum all of the weighed point-scores over the sector generated when a cone with head angle of 60° and located at the center of the sphere intersects the reachable part of the hemisphere given the mechanism joint constraints previously defined. This score provides an average performance over the entire section intersected by the cone.

Given the ranges of the azimuth angle a and the elevation angle ζ, defining the intersection area between a right circular cross section cone with a vertex angle of 60° located at the center of the sphere and the sphere itself, the set of all possible intersection areas on the hemisphere is
K={k(σ.ζ):0<σ<2*π,0<ζ<π/4}

The set of all the discrete points contained in the intersection area is
k_{σ,ζ}^{p}⊂k_{σ,ζ}

Due to the discrete nature of the computation, each point included in the intersection area has an associated isotropy value ISO and sector area A. Thus the overall scoring functions are

$$\begin{matrix}{s}_{sum} = {MAX}_{K} \{ {\sum }_{{k}_{σ , ζ}^{p}} ISO ( {θ}_{1} , {θ}_{3} ) * A ( σ , ζ ) \} & ( a ) & ( 12 ) \\ {S}_{min} = {MAX}_{K} \{ {MIN}_{{k}_{σ , ζ}^{p}} ( ISO ( {θ}_{1} , {θ}_{3} ) ) \} & ( b ) & \end{matrix}$$

There are a number of orientations of the DWS with respect to the hemisphere, noted as the set K. For each element of K, the summed isotropy is different. The value considered is the highest value of the summed isotropy score, which is fuirther referred as Sₛᵤₘ. In other words, each design candidate has a Sₛᵤₘ value that corresponds to the highest summed isotropy score for that design.

The limitation of a summed isotropy score is that singularities or workspace boundaries could exist within a region that has a good score. The minimum isotropy value within the cone intersection area is an indicator of the worst performance that can be expected over that cone intersection area. For each element in K, the minimum isotropy is different. The value returned is the highest minimum isotropy score on the set of all cones, K, referred to as Sₘᵢₙ. In other words, each design candidate has a Sₘᵢₙ value that corresponds to the best of all possible worst-case isotropy scores for that design.

A design with greater link angles will have a larger reachable workspace and generally better Sₛᵤₘ and Sₘᵢₙ values.

The drawback to larger link angles is a decrease in link stiffness and greater bulk. As suggested by the experimental findings, in surgery the mechanism is operated in a limited workspace. According to one example, the goal is to maximize the kinematic performance over the surgical workspace while minimizing the link length. Static analysis of a cantilever beam shows that the arm stiffniess is inversely proportional to the cube of length.

The overall score for a design candidate with link lengths α₁₃ and α₃₅, taking into account all three criteria is defined as follows:

$$ϕ = \frac{{S}_{sum} \cdot {S}_{min}}{{( {α}_{13} + {α}_{35} )}^{3}} \qquad ( 13 )$$

According to one example, a requirement of the optimization is that over the DWS or EDWS, the mechanism does not encounter any singularities or workspace boundaries. By multiplying the summed isotropy by the minimum isotropy, candidates that fail to meet this requirement have a score of zero. By dividing by the cube of the sum of the link angles the score reflects proportionality to the mechanisms stiffness or mass. Thus, over a scan of the potential design space, the peak composite score represents a design with maximum average performance, a guaranteed minimum performance and maximized stiffniess.

In one example, the optimization considered all combinations of α₁₃ and α₃₅ from 16° to 90° in 2° increments for a total of 1444 design candidates. The hemisphere was discretized into 3600 points, distributed evenly in azimuth and elevation.

$$min ϕ ( {α}_{13} , {α}_{35} , {θ}_{1} , {θ}_{3} ) \{ \begin{matrix}16 ° < {α}_{13} < 90 ° \\ 16 ° < {α}_{35} < 90 ° \\ {θ}_{1} ∈ DWS \\ {θ}_{3} ∈ DWS\end{matrix} \qquad ( 14 )$$

Considering the DWS, its orientation in azimuth and elevation were varied in order to obtain the best cone for that design candidate. However, optimizing the EDWS, which is an elliptical cone, would add another design parameter, namely cone roll angle. Introducing an additional parameter will increase execution time of the optimization by an order of magnitude. By utilizing a 90° cone that encompasses the EDWS, a superset of the EDWS was created which eliminates the additional design parameter. However, using a superset of the EDWS could force the link lengths to be larger than necessary. For example a design that can reach 60° in one direction and 90° in an orthogonal direction satisfies the EDWS cone but not a 90° cone.

Using the definition of the scoring criteria a numerical scan of the design space was performed using all the combinations of link angles α₁₃ and α₃₅ in the range of 16° to 90°. Optimizing on the DWS, the best design was achieved with link angles of α₁₃=52° and α₃₅=40° and a score of 0.0520. In contrast, running the same optimization but requiring a 90° cone indicated that the optimal mechanism design has link angles α₁₃=90° and α₃₅=72° with a score of 0.0471.

The difference in the results is not unexpected but it does pose an interesting dilemma. If one chooses the design that optimizes on a 90° cone, the resulting design should be more likely to reach all the poses that manipulator would be asked to reach. However, this design has lower overall performance than the design optimized for the DWS and larger links, which may increase the likelihood for problems of collisions between two manipulators.

One interesting consideration is to take the best design that is optimized for the DWS that also has the ability to reach a 90° cone. This is done by taking the set of designs from the 90°-cone optimization with a non-zero score (these are all designs which have some 90° cone that contains no singularities) and run an optimization on this subset of designs. Effectively it takes the DWS optimization and slices out the designs that cannot reach a 90° cone.

The resulting peak in the design space is α₁₃=74° and α₃₅=60° with a score of 0.0367. This design is a compromise of the DWS optimization and the 90° cone optimization. However as discussed earlier, optimization on a 90° cone may result in a design that is larger than needed. The workspace of the optimal design for the DWS (α₁₃=52° and α₃₅=40°) is a slice of a sphere.

The foregoing describes development of the kinematic equations for the serial spherical manipulator with arbitrary link angles. Optimization of the mechanism specifically for surgery yields a more compact device than a general spherical manipulator. The optimization balanced between a guaranteed minimum and integrated isotropy over the DWS as well as total link length in order to yield a very compact, high-dexterity mechanism.

Other design and performance parameters can also be evaluated. For example, a metric corresponding to dynamic performance can be selected. As another example, optimal placement of two or more manipulators over a patient can be determined based on parameters such as robot-patient collisions as well as robot-robot collisions and self-collision.

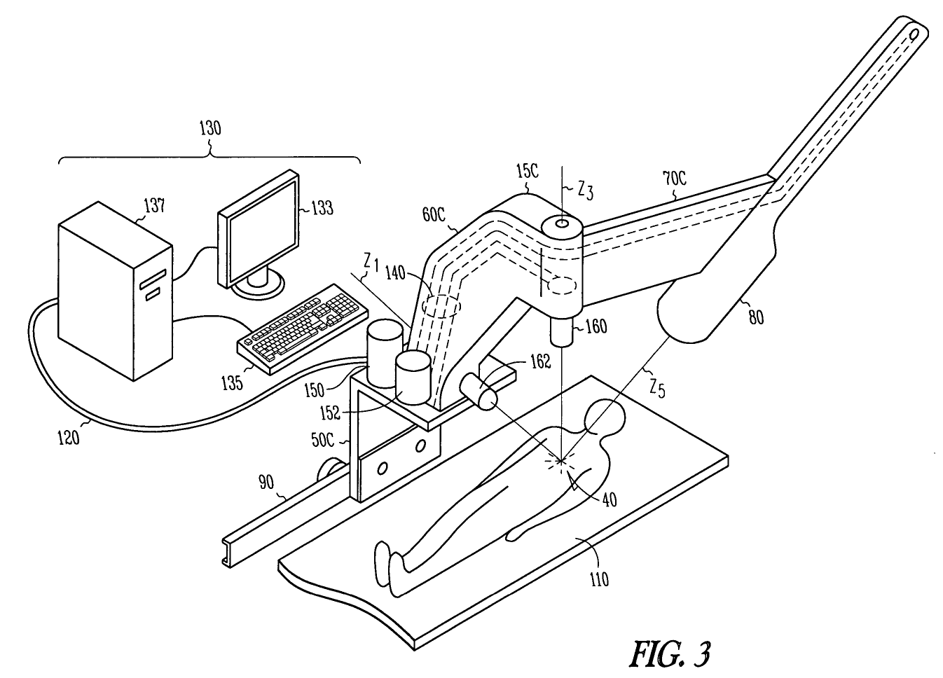

FIG. 3 illustrates spherical motion mechanism 15C affixed to track 90 aligned with platform 110. Track 90 allows base 50C to travel along the length of a patient on platform 110. Base 50C also provides mounting for drive motors 150 and 152, each of which are coupled to particular elements of mechanism 15C by cable actuators 140 routed within the structure of link 60C and link 70C. The routing of cable actuators 140 is configured such that the cable remains taut and direction changes are aligned about axes Z₁, Z₃ and Z₅. In addition, the figure illustrates light sources 160 and 162 also aligned with axes Z₁ and Z₃. An additional light source (not shown) can be aligned with axis Z₅. Light sources 160 and 162, in one example, include laser diodes configured to project a pinpoint light source at center 40. According to one example, adjusters on base 50C allow an operator to align mechanism 15C to co-locate center 40 with a trocar of the patient.

In one example, the cable actuators are routed over pulleys configured on bearings that are aligned with the revolute joints. In the example illustrated, the drive motors are mounted on the stationary base 50C, thus reducing the mass articulated on the revolute joints. In one example, a helical groove on the motor shaft engages a cable routed through the mechanism. The cable is coupled to a linear bearing which carries an instrument or tool aligned with axis Z₅.

In one example, a light source generates a pattern that facilitates alignment of the axes with a trocar or other target location. Such patterns include, for example, a bull's-eye pattern, a cross-hair pattern concentric circles or other such shapes to facilitate alignment. The wall thickness or irregularities in the body position can blur the alignment and a cross-hair pattern, for example, allows alignment without regard to wall thickness. Light sources 160 and 162, in one example, include threaded fasteners that align with the axes of the revolute joints.

Mechanism 15C is coupled to computer 130 by connecting line 120. In one example, computer 130 includes processor 137, user input device 135 such as a keyboard, mouse or other controller, and display 133 or printer. Processor 137 includes a memory and is configured to execute a set of instructions to perform a method as described elsewhere in this document.

Instrument 80, in the example illustrated includes a tool affixed to a prismatic joint. In one example, instrument 80 includes an optical instrument or other device aligned with center 40 through axis Z₅. Motion of instrument 80 can include travel along axis Z₅ or rotation about axis Z₅.

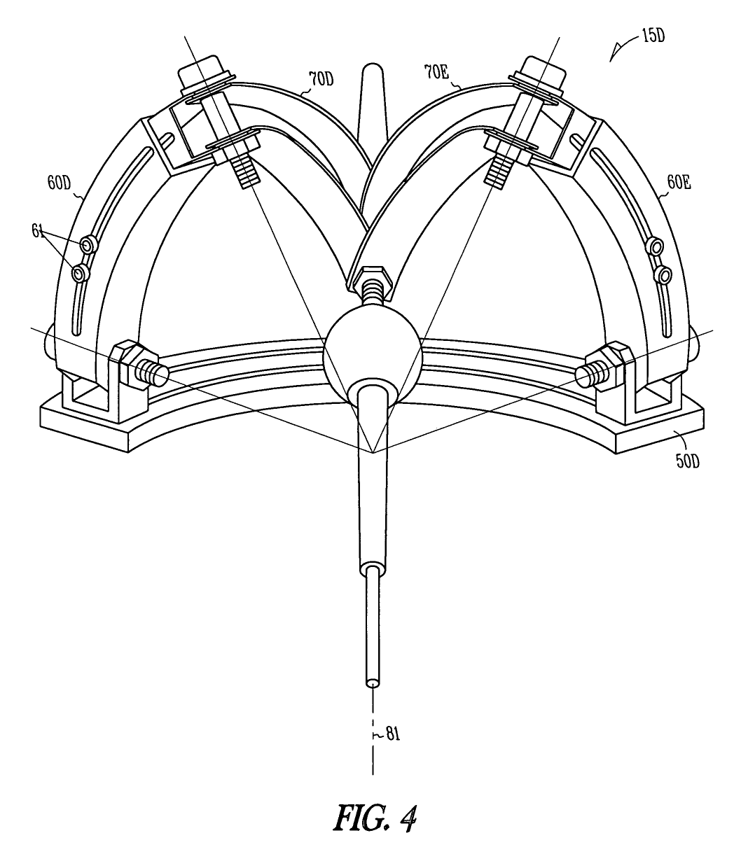

FIG. 4 illustrates a view of an exemplary parallel spherical motion mechanism 15D mounted on base 50D. Base 50D includes a curved structure having slotted holes to receive base joints coupled to link 60D and link 60E. In the example illustrated, link 60D and link 60E have adjustable length and are secured by locking screws 61. For example, by reducing the overall length of link 60D and link 60E, the mechanism is reduced in size and provides motion throughout a smaller cone. In the example illustrated, a change in the length of a link will change the angle of the axes of the revolute joints. Link 70D and 70E terminate at a common revolute joint through which tool axis 81 is aligned. In other examples, a spherical motion mechanism according to the present subject matter includes a link having a fixed (non-adjustable) length or angle.

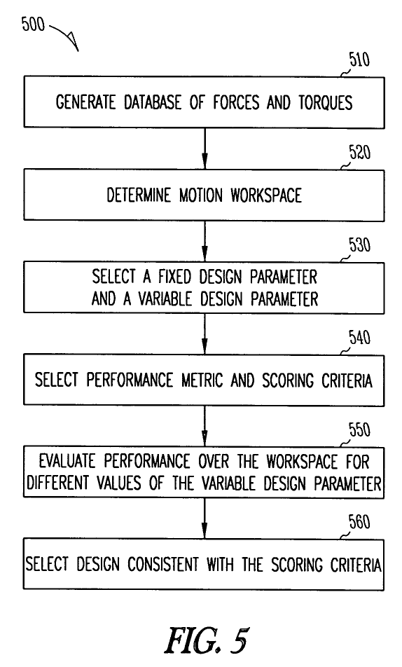

FIG. 5 includes flowchart 500 that describes a design method corresponding to the present subject matter. The method can be implemented by a processor executing a set of instructions, an analog computer or other machine. For example, at 510, a database of forces, torque and other measured date is generated. In the foregoing example, data was collected based on measured parameters during surgical procedures with a number of physicians.

At 520, the motion workspace is determined. In the example, the dexterous workspace and the extended dexterous workspace was defined in terms of a mathematical relationship.

At 530, the fixed design parameters and variable design parameters are selected. The parameters can include such values as the length of each linkage element, the overall radius between the center point and the linkage as well as the angle corresponding to the revolute joints and the center point. Other parameters can also be selected.

At 540, at least one performance metric or scoring criteria is selected for use in comparing the various designs generated. In the example above, the designs were evaluated based on a ratio tailored to heavily penalize designs having long linkage elements. The design preference, according to this metric, reflects favoring a shorter and more compact structure.

At 550, the method includes evaluating the different designs for performance over the workspace using different values of the variable design parameter. In one example, the workspace is evaluated with a granularity of 2 degrees.

At 560, a target design is selected based on the scoring criteria. In various examples, the selection process may include minimizing, maximizing or meeting a particular numeric value.

Other methods are also contemplated for selecting a particular design. For example, one method provides maintaining a constant radius and selecting angles based on a desired range of motion. Other methods entail selecting both a radius and an angle or other combinations to provide the desired motion.

In addition to the aforementioned tools or instruments, the present subject matter can be configured for use with optical devices such as a light source, a mirror or a camera. Audio devices such as a microphone or sound generator or ultrasonic transducer are also contemplated. In one example, a manipulator device is used. A representative manipulator device includes a grasper, a paddle, a spatula, or a stent delivery device. Furthermore, the tool can include a biopsy probe or other device for extracting a sample or a drug delivery device. An electrical tool can include a cauterizing tool or a sensor such as a pressure or temperature sensor.

The figures illustrate serial and parallel structures, however, other combinations are also contemplated. For example, one embodiment includes three sets of links configured in a parallel manner to constrain motion about a sphere. As such, the motion of the tool is limited to travel along or about an axis through the center of the sphere.

The joint axes of the present subject matter converge to the center of a sphere. In contrast, the joint axes of a planar machine are generally parallel and the links lie in a plane.

In one example, a first spherical motion mechanism and a second spherical motion mechanism are affixed to a common base and have end effectors linked by a linear member. In one example, the range of motion of a revolute joint is limited, for instance, by a mechanical stop.

The end effector, in various examples, includes a tool receiver configured to receive one or more of a variety of tools or instruments. Each tool or instrument can have, for example, a prismatic joint or other combination of up to three independent axis of motion.

In one example, the mechanism is powered by one or more electric motors. Other drivers are also contemplated, including, for example, manual motion, hydraulic or pneumatic actuators.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including“ and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A device comprising:
a first link having ends terminated in a base revolute joint and a common revolute joint, the revolute joints having convergent rotational axes and each rotational axis forming an acute angle with a longitudinal axis of the first link; and
a second link coupled to the common revolute joint at a first end, the rotational axis of the common revolute joint forming an acute angle with a longitudinal axis of the second link.

2. The device of claim 1 wherein a second end of the second link includes a tool holder.

3. The device of claim 2 wherein the tool holder has a tool axis aligned to pass through a point coincident with an intersection of the convergent rotational axes.

4. The device of claim 1 wherein the convergent rotational axes subtends an angle of less than 90 degrees.

5. The device of claim 1 wherein a second end of the second link includes a tool holder having a tool axis aligned to pass through a point coincident with an intersection of the convergent rotational axes; and
wherein the tool axis and the common revolute joint rotational axis subtends a first angle; and
wherein the convergent rotational axes subtends a second angle; and
wherein the first angle differs from the second angle.

6. The device of claim 1 further including a light source coupled to at least one rotational axis and wherein illumination from the light source is directed toward an intersection of the convergent rotational axes.

7. The device of claim 1 further including a cable routed along the first link and coupled to a tool affixed to a second end of the second link wherein the tool has an axis aligned to pass through a point coincident with an intersection of the convergent rotational axes and such that the cable provides motion to the tool.

8. A method comprising:
providing a first joint coupled to a base and having a first rotational axis;
pivotally coupling a first link to the first joint at a first end wherein the first rotational axis and a first longitudinal axis of the first link form an acute angle, the first link having a second end;
forming a second joint having a second rotational axis at the second end, wherein the second rotational axis and the first longitudinal axis form an acute angle; and
coupling a second link to the second joint at a third end of the second link, the second link having a second longitudinal axis wherein the second longitudinal axis and the second rotational axis form an acute angle.

9. The method of claim 8 further including affixing a light source to at least one of the first joint and the second joint.

10. The method of claim 8 further including providing a receiver on the second link, the receiver configured to receive an instrument.

11. The method of claim 8 further including coupling an electric actuator to the first link.

12. The method of claim 8 further including coupling an electric actuator to the second link.

13. The method of claim 8 further including coupling an electric control to at least one of the first joint and the second joint.

14. A system including:
a subject platform;
an alignment mechanism coupled to the subject platform, the alignment mechanism having a first link coupled to a base by a first revolute joint and a second link coupled to the first link by a second revolute joint, wherein the revolute links have convergent rotational axes that subtend an acute angle and wherein the second link includes an instrument holder;
a driver coupled to the alignment mechanism and configured to control a position of at least one of the first link and the second link; and
a controller coupled to the driver.

15. The system of claim 14 wherein the instrument holder is configured to receive an optical element, a probe, a sensor or a manipulator device.

16. The system of claim 14 wherein the driver includes an electric motor affixed to the base.

17. The system of claim 16 wherein the driver includes a cable and pulley coupled to the at least one of the first link and the second link.

18. The system of claim 14 further including a light coupled to at least one of the first revolute joint and the second revolute joint.

19. The system of claim 14 wherein the tool holder includes a linear actuator.

20. The system of claim 14 further including a second alignment mechanism coupled to the subject platform, the second alignment mechanism having a first link and a second link coupled to a revolute joint wherein an end of the second link is configured to travel in a sphere.

21. The system of claim 14 further including:
a processor configured to communicate with the driver; and
a user control communicatively coupled to the processor and configured to receive a user input for control of the alignment mechanism.
